(19) United States
(12) Patent Application Publication
(10) Pub. No.: US 2022/0192355 A1
(43) Pub. Date: Jun. 23, 2022

(54) APPARATUS AND METHOD FOR DIFFERENTIATING PRESSURE

(71) Applicant: KONINKLIJKE PHILIPS N.V., EINDHOVEN (NL)

(72) Inventor: Nathan FARRELL, Kirkland, WA (US)

(21) Appl. No.: 17/606,168

(22) PCT Filed: Apr. 22, 2020
(86) PCT No.: PCT/EP2020/061165

§ 371 Date: Oct. 25, 2021

Related U.S. Application Data
(60) Provisional application No. 62/838,572, filed on Apr. 25, 2019.

(51) Int. Cl. A46B 9/04; A46B 15/00; A61C 17/32; A61C 17/22

(52) U.S. Cl. CPC A46B 9/04; A46B 15/0012; A46B 2200/1066; A61C 17/221; A61C 17/32

(57) ABSTRACT

A personal care appliance having a brush head assembly, the brush head assembly including a neck having a first end and a second end, a brush head arranged proximate the first end of the neck. The brush head including a first face fixedly secured to a plurality of bristles, the plurality of bristles arranged to extend from the first face in a first direction, and a second face arranged to create a first frictional force between the second face and an oral environment in a second direction, and create a second frictional force between the second face and the oral environment in a third direction.

### FIELD OF THE DISCLOSURE

The present disclosure is directed generally to personal care appliances, more specifically to oral care appliances, even more specifically, to oral care appliances arranged to differentiate pressure within an oral environment.

### BACKGROUND

Personal care appliances, for example, power toothbrushes, contain components which generate rotational motion of a drive shaft which creates a proportional rotational motion or a translational motion of a brush head arranged to contact the teeth and gums of a user. Power toothbrushes also contain components which can detect various conditions and/or states of the appliance and provide feedback to the user. For example, feedback may be provided which indicates that the user is applying excessive pressure between the user's teeth and/or gums and the bristles of the power toothbrush. In use, the bristles of a toothbrush should lightly skim the tooth surfaces to remove bacteria, food debris, and plaque. Increasing the pressure with which the user applies the bristles to the teeth does not aid the cleaning process and may damage the internal components of the power toothbrush and/or damage the user's teeth and gums. Additionally, increasing the pressure on the bristles may slow the speed of bristle vibration or stop the bristles from moving across the teeth lowering their effectiveness.

### SUMMARY OF THE DISCLOSURE

The present disclosure is related to a personal care appliance which includes a brush head assembly having a brush head which includes a first face having a plurality of bristles arranged to extend from the first face of the brush head in a first direction, and a second face arranged to create a first frictional force between the second face and an oral environment in a second direction, and create a second frictional force between the second face and the oral environment in a third direction. The difference between the first and second frictional force can be used to differentiate pressure on the personal care appliance generated from the oral environment on the brush head assembly from pressure generated by the user on the personal care appliance.

In one aspect, there is provided a brush head assembly for a personal care appliance, the brush head assembly including a brush head, the brush head including a first face fixedly secured to a plurality of bristles, the plurality of bristles arranged to extend from the first face in a first direction; and a neck having a first end and a second end, the neck or the brush head further including a second face arranged to create a first frictional force between the second face and an oral environment in a second direction, and create a second frictional force between the second face and the oral environment in a third direction.

In one aspect, the second face further comprises a first friction surface having a first coefficient of friction and a second friction surface having a second coefficient of friction, where the second coefficient of friction is different than the first coefficient of friction.

In one aspect, the second face further comprises a first plurality of protrusions, the first plurality of protrusions including a first protrusion, the first protrusion having a first side and a second side, wherein the first friction surface is arranged on the first side of the first protrusion and the second friction surface is arranged on the second side of the first protrusion.

In one aspect, the second face further comprises a third friction surface having the first coefficient of friction and a fourth friction surface having the second coefficient of friction wherein the first coefficient of friction and the second coefficient of friction are not equal.

In one aspect, the first plurality of protrusions includes a second protrusion, the second protrusion having a third side and a fourth side, wherein the third friction surface is arranged on the third side of the second protrusion and the fourth friction surface is arranged on the fourth side of the second protrusion.

In one aspect, the first friction surface comprises a first friction material having the first coefficient of friction along the second direction and a second friction material having a second coefficient of friction along the third direction.

In one aspect, there is provided a personal care appliance, the personal care appliance including a brush head assembly and a body portion, the brush head assembly including a neck having a first end and a second end, a brush head arranged proximate the first end of the neck, the brush head including a first face fixedly secured to a plurality of bristles, the plurality of bristles arranged to extend from the first face in a first direction, and, a second face having a first friction surface arranged thereon, the first friction surface having a first coefficient of friction. The body portion having a housing, the housing having third end and a fourth end, the housing comprising a cavity therein, the cavity including a drive shaft arranged proximate the third end of the body portion and arranged to engage with the second end of the neck, a drive assembly arranged to generate an oscillation of the drive shaft and, via the drive shaft, generate an oscillation of the brush head, and a first sensor arranged to determine a first force exerted by an oral environment on the second face of the brush head in the first direction based at least in part on a first frictional load between the first friction surface of the second face of the brush head and the oral environment in a second direction, wherein the second direction is orthogonal to the first direction.

In one aspect, the second face of the brush head further comprises a second friction surface having a second coefficient of friction, where the second coefficient of friction is different than the first coefficient of friction.

In one aspect, the second face of the brush head further comprises a first plurality of protrusions, the first plurality of protrusions including a first protrusion, the first protrusion having a first side and a second side, wherein the first friction surface is arranged on the first side of the first protrusion and the second friction surface is arranged on the second side of the first protrusion.

In one aspect, the second face of the brush head further comprises a third friction surface having the first coefficient of friction and a fourth friction surface having the second coefficient of friction wherein the first coefficient of friction and the second coefficient of friction are substantially equal.

In one aspect, the first plurality of protrusions includes a second protrusion, the second protrusion having a third side and a fourth side, wherein the third friction surface is arranged on the third side of the second protrusion and the fourth friction surface is arranged on the fourth side of the second protrusion.

In one aspect, the first friction surface comprises a first friction material having the first coefficient of friction along the second direction and a second friction material having a second coefficient of friction along a third direction where the third direction is opposite the second direction.

In one aspect, a method of differentiating pressure on a personal care appliance is provided, the method including: providing a brush head assembly having brush head, the brush head having a first face and a second face, the first face arranged to engage with a plurality of bristles extending therefrom in a first direction and a second face having a first friction surface arranged thereon, the first friction surface having a first coefficient of friction; providing, within a housing of the personal care appliance, a drive assembly arranged to engage with the brush head assembly via a drive shaft and transfer an oscillation of a drive assembly to the brush head; and, sensing, via a first sensor arranged within the housing, a first pressure exerted by an oral environment on the second face of the brush head in the first direction based at least in part on a first frictional load between the first friction surface of the second face of the brush head and the oral environment in a second direction, wherein the second direction is orthogonal to the first direction.

In one aspect, the second face of the brush head further comprises a second friction surface having a second coefficient of friction, where the second coefficient of friction is different than the first coefficient of friction.

In one aspect, the first friction surface comprises a first friction material having the first coefficient of friction along the second direction and a second friction material having a second coefficient of friction along a third direction where the third direction is opposite the second direction.

These and other aspects of the various embodiments will be apparent from and elucidated with reference to the embodiment(s) described hereinafter.

### BRIEF DESCRIPTION OF THE DRAWINGS

In the drawings, like reference characters generally refer to the same parts throughout the different views. Also, the drawings are not necessarily to scale, emphasis instead generally being placed upon illustrating the principles of the various embodiments.

FIG. 1 is a front perspective view of a personal care appliance according to the present disclosure.

FIG. 2 is a side view of a personal care appliance according to the present disclosure.

FIG. 3 is a detail side view of a personal care appliance in an oral environment according to the present disclosure.

FIG. 4A is a top plan view of a personal care appliance according to the present disclosure.

FIG. 4B is a back view of a personal care appliance according to the present disclosure.

FIG. 5 is a schematic representation of a surface of a brush head of a personal care appliance according to the present disclosure.

FIG. 6A is a right side schematic representation of a brush head according to the present disclosure.

FIG. 6B is a right side schematic representation of a brush head according to the present disclosure.

FIG. 7 illustrates a flow chart of a method according to the present disclosure.

### DETAILED DESCRIPTION OF EMBODIMENTS

The present disclosure describes various embodiments of a personal care appliance which includes a brush head assembly having a brush head which includes a first face having a plurality of bristles arranged to extend from the first face of the brush head in a first direction, and a second face arranged to create a first frictional force between the second face and an oral environment in a second direction, and create a second frictional force between the second face and the oral environment in a third direction. The difference between the first and second frictional force can be used to differentiate pressure on the personal care appliance generated from the oral environment on the brush head assembly from pressure generated by the user on the personal care appliance.

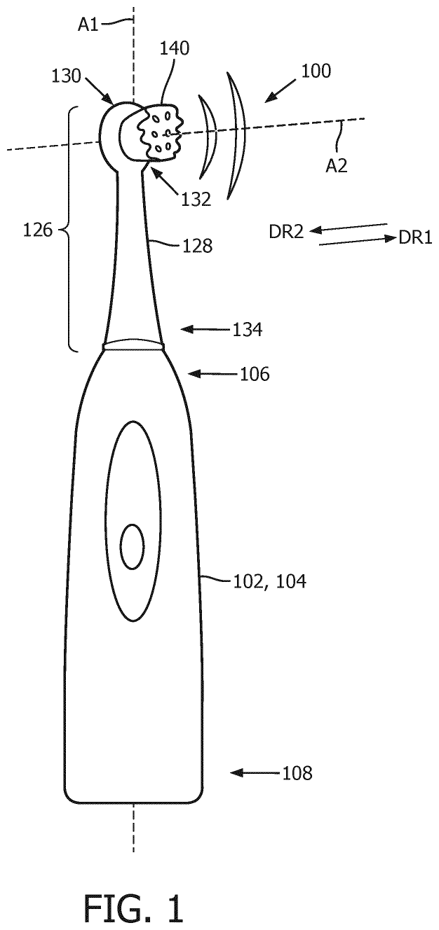

The following description should be read in view of FIGS. 1-4. FIG. 1 is a perspective view of personal care appliance 100. Broadly, personal care appliance 100 comprises body portion 102 having housing 104. Housing 104 has first end 106, second end 108 and is intended to be substantially hollow, i.e., having a cavity 110 arranged therein. In one example, housing 104 is arranged such that first end 106 and second end 108 are centered about a first axis A1 .

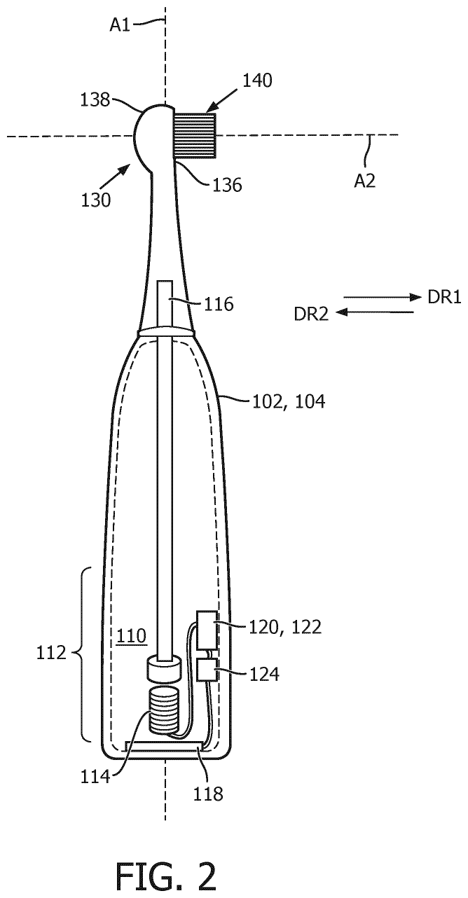

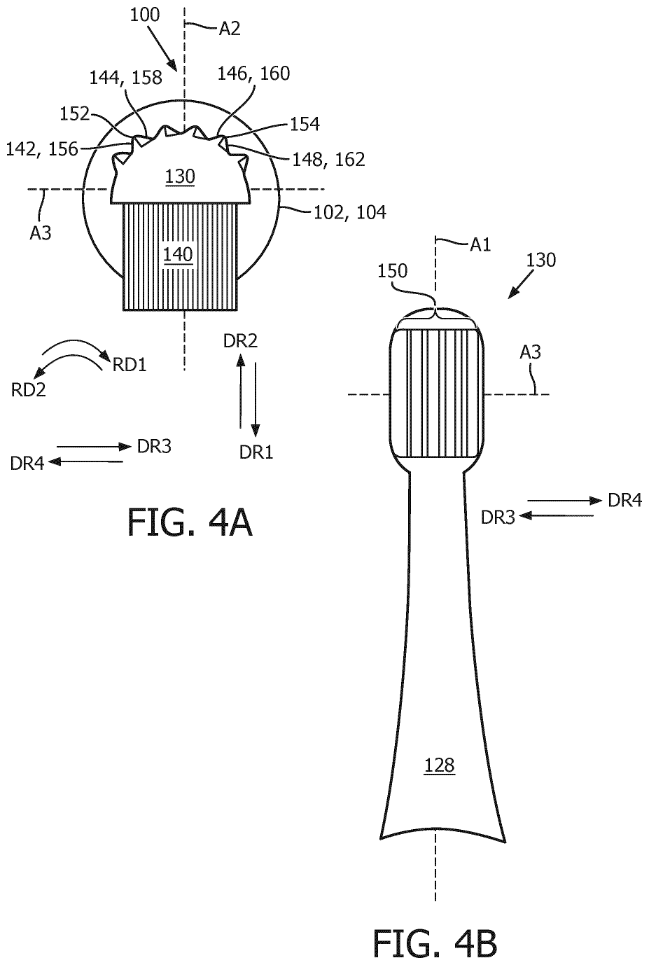

As illustrated in FIG. 2, Cavity 110 includes a drive assembly 112. Drive assembly 112 can include a various electronic components arranged to drive or actuate the components of brush head assembly 126 discussed below. For example, drive assembly 112 can include motor 114, drive shaft 116, power supply 118, processor 120, and memory 122. Motor 114 is arranged to receive an electrical input and generate rotational motion of drive shaft 116. Motor 114 can be a direct drive motor, i.e., any motor arranged to receive an input current and generate rotation of drive shaft 116 directly. Additionally, and as illustrated in FIG. 2, motor 114 can be a magnetic motor coupling, i.e., motor 114 can include an electromagnetic stator arranged to generate an alternating magnetic field and drive shaft 116 may include a magnet at one end arranged to receive the alternating magnetic field and rotate in a first rotational direction RD1 (shown in FIG. 4A) and a second rotational direction RD2 (shown in FIG. 4A) in an oscillating manner.

Drive shaft 116 is intended to be a substantially longitudinal member arranged along first axis A1 at least between first end 106 and second end 108 of housing 104. Drive shaft 116 is arranged to rotate and oscillate about first axis A1 in a first rotational direction RD1 (shown in FIG. 4A) and a second rotational direction RD2 (shown in FIG. 4A) in response to an alternating magnetic field generated by motor 114 as described above. In one example, one end of drive shaft 116 is arranged to be removably secured to brush head assembly 126, discussed below, and drive the vibration or oscillating functionality of brush head 130 while in use by a user. Power supply 118 is arranged within housing 104 and proximate second end 108 of housing 104. Power supply 118 is intended to be a battery capable of inductive charging; however it should be appreciated that any power source, wireless or wired, capable of driving motor 114 of drive assembly 112 can be utilized. Processor 120 and memory 122 are arranged to execute and store, respectively, a set of non-transitory computer readable instructions arranged to receive data from at least sensor 124, discussed below, and generate the electric signals required to operate drive system 112.

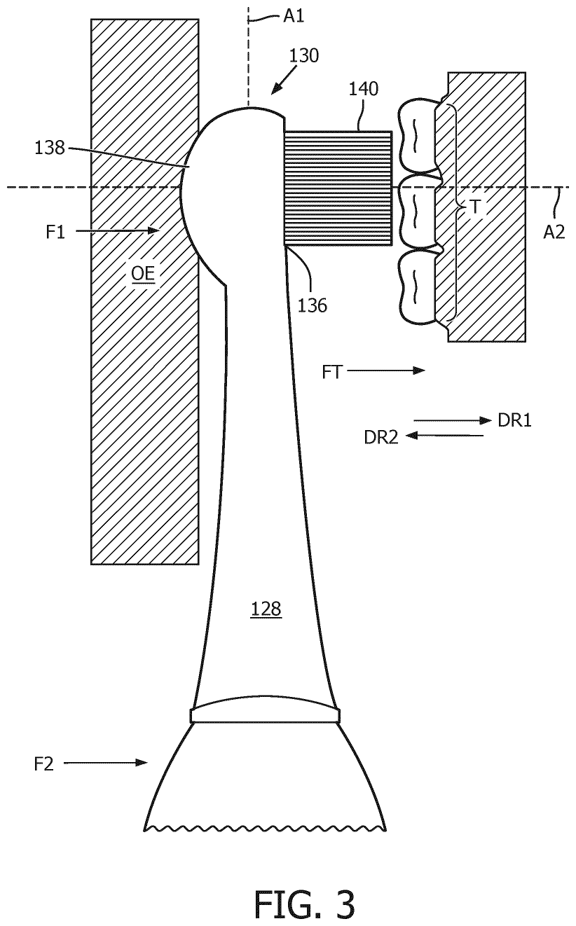

Cavity 110 further includes first sensor 124, which is arranged to, for example, measure changes in torque during operation of motor 114. Although illustrated as an separate component, it should be appreciated that sensor 124 can be integrated within motor 114 such that it may provide load or current information to the other internal electronic components discussed above during operation of personal care appliance 100. For example, sensor 124 is arranged to obtain a first load L1 (not shown) during a first stroke of brush head 130, i.e., when brush head 130 moves within oral environment OE (shown in FIG. 3) in third direction DR3 (shown in FIG. 4A) and obtain a second load L2 (not shown) during a second stroke of brush head 130, i.e., when brush head 130 moves within oral environment OE in fourth direction DR4 (shown in FIG. 4A). It should be appreciated that the first stroke and second stroke, in the alternative to corresponding to translational motion in third direction DR3 and fourth direction DR4, respectively, could also correspond to a rotation of brush head 130 in first rotational direction RD1 and second rotational direction RD2 about first axis A1, e.g., if the brush head is selected from a rotary style brush head.

Personal care appliance 100 further includes a brush head assembly, i.e., brush head assembly 126. Brush head assembly 126 is arranged to removably engage with drive shaft 116 and secure to body portion 102 proximate first end 106. Brush head assembly 126 includes neck 128 and brush head 130. Neck 128 has first end 132 and second end 134. When engaged, brush head 130 is integrally connected to first end 132 of neck 128 and second end 134 is arranged proximate first end 106 of body portion 102. Additionally, when engaged, brush head assembly 126 is positioned substantially about first axis A1 and secured to drive shaft 116 such that rotation and/or oscillation of drive shaft 116 corresponds to a translational oscillation of brush head 130 along second axis A2 in third direction DR3 and fourth direction DR4, and/or corresponds to a rotational oscillation about first axis A1 in a first rotational direction RD1 and a second rotational direction RD2. It should also be appreciated that brush head assembly 126 may also rotate about second axis A2 and/or translate along first axis A1.

As shown in FIGS. 2-4A, brush head 130 further includes a first face 136 and a second face 138. First face 136 is arranged on an opposing side of brush head 130 than second face 138, i.e., first face 136 is arranged on brush head 130 and in first direction DR1 along second axis A2, and second face 138 is arranged on brush head 130 and in second direction DR2, where second direction DR2 is opposite first direction DR1. First face 136 comprises a plurality of bristles 140. Plurality of bristles 140 are arranged to extend from first face 136 substantially in first direction DR1 along second axis A2 and contact a user's teeth T (shown in FIG. 3) during operation of personal care appliance 100. It should be appreciated that plurality of bristles 140 can also extend from first face 136 substantially in first direction DR1 and at an angle with respect to third axis A3, i.e., plurality of bristles 140 can include angled bristles.

As illustrated in FIG. 4A, second face 138 comprises a plurality of friction surfaces, i.e., first friction surface 142, second friction surface 144, third friction surface 146, and fourth friction surface 148. First friction surface 142 and third friction surface 146 comprise a material having a first coefficient of friction FR1. Furthermore, second friction surface 144 and fourth friction surface 148 have a second coefficient of friction FR2, where second coefficient of friction FR2 is different that first coefficient of friction FR1. These frictional surfaces are arranged to contact portions of the oral environment OE inside the user's mouth during normal operation of personal care appliance 100. It should be appreciated that, although not illustrated, second face 138 may be disposed on neck 128, such that the frictional surfaces discussed herein may contact a user's lip during operation of personal care appliance 100.

In one example, second face 138 includes a plurality of protrusions 150 (shown in FIG. 4A) extending in the second direction DR2 along second axis A2. Plurality of protrusions 150 can include, for example, first protrusion 152 and second protrusion 154. First protrusion 152 has a first side 156 and a second side 158, and second protrusion 154 has a third side 160 and a fourth side 162. First side 156 of first protrusion 152 and third side 160 of second protrusion 154 are arranged such that they extend from second face 138 in second direction DR2 and substantially face fourth direction DR4. Second side 158 of first protrusion 152 and fourth side 162 of second protrusion 154 are arranged such that they extend from second face 138 in second direction DR2 and substantially face third direction DR3. First side 156 of first protrusion 152 and third side 160 of second protrusion 154 include first friction surface 142 and third friction surface 146, respectively. Second side 158 of first protrusion 152 and fourth side 162 of second protrusion 154 include second friction surface 144 and fourth friction surface 148, respectively. This arrangement produces an anisotropic effect to brush head 130 during operation, i.e., brush head 130 experiences a different frictional force or load when moving in third direction DR3 than it experiences while moving in fourth direction DR4. It should be appreciated that although plurality of protrusions 150 are illustrated as a series of ridges having respective faces, it should be appreciated that protrusions 150 can take any form which would allow for a substantial portion of first friction face 142 and third friction face 146 to contact oral environment OE when brush head 130 moves in third direction DR3 and allow a substantially portion of second friction surface 144 and fourth friction surface 148 to contact oral environment OE when brush head 130 moves in fourth direction DR4. It should also be appreciated that generation of the anisotropic effect described above can be accomplished with two friction surfaces, i.e., the device may include a first friction surface and a second friction surface where a substantial amount of the first friction surface is arranged to contact the oral environment when brush head 130 moves in third direction DR3 and a substantial amount of the second friction surface is arranged to contact the oral environment when brush head 130 movies in fourth direction DR4, and the first friction surface has a first coefficient of friction and the second friction surface has a second coefficient of friction where the first coefficient of friction and the second coefficient of friction are different. It should be appreciated that the foregoing friction surfaces may also be arranged on the first end 132 of neck 128 of brush head assembly 126.

During operation of personal care appliance 100, a user may place oral care appliance 100 within an oral environment OE, i.e., within the user's mouth. Within the user's oral environment OE, the inside of the user's cheek, a portion of the user's lips, or at least a portion of the user's tongue may apply a pressure or force F1 (shown in FIG. 3) to second face 138 of brush head 130 in first direction DR1 along second axis A2. Additionally, the user's hand may be positioned on housing 104 of personal care appliance 100 such that when in use, the user's hand applies a second force F2 (shown in FIG. 3) on personal care appliance 100 in the first direction DR1. As shown in FIG. 3, the total pressure and/or total force FT on the user's teeth by plurality of bristles 140 in first direction DR1 is:

FT=F1+F2

In the above example, sensor 124 may perceive the torque or load on motor 114 and determine that FT exceeds a certain threshold, i.e., the bristles of plurality of bristles 140 are applying too much total force on the user's teeth, which may cause damage to personal care appliance 100 and/or the user's teeth. However, the user has no way of distinguishing whether the total force FT exerted on brush head 130 in first direction DR1 is caused by excessive force from the user's oral environment OE, i.e., first force F1, or caused by excessive force on the housing 104 of oral care appliance 100 in first direction DR1, i.e., second force F2.

As described above, to aid in distinguishing the source of the excessive force, second face 138 of brush head 130 includes at least two surfaces, i.e., first friction surface 142 and second friction surface 144, having a first coefficient of friction FR1 and second coefficient of friction FR2, respectively, where the first coefficient of friction FR1 is different than second coefficient of friction FR2. In one example, first friction surface 142 comprises a nylon material having first coefficient of friction FR1 of approximately 0.25 and second friction surface 144 comprises a Thermoplastic Elastomer (TPE) material having second coefficient of friction of approximately 0.5. It should be appreciated that the materials chosen for first friction surface 142 and second friction surface 144 can be any material or combination of materials which can produce a sufficient different in frictional drag in the first stroke in the third direction DR3 and the second stroke in fourth direction DR4 such that sensor 124 can perceive the difference in current or load of motor 114. The anisotropic effect created by these two friction surfaces, i.e., the frictional drag of second face 138 against oral environment OE in third direction DR3 is different than the frictional drag of second face 138 against oral environment OE in fourth direction DR4, creates two different torques or loads during the first stroke in the third direction DR3 and the second stroke in the fourth direction DR4, i.e., first load L1 and second load L2, on motor 114 which can be detected by first sensor 124 and utilized by processor 120 to determine the values of first force F1 and second force F2. For example, processor 120 may utilize the following two formulas to determine the force on brush head 130 caused solely by oral environment OE, i.e., first force F1, where R is the distance between second surface 138 and axis A1:

$$\begin{matrix}{F}_{Delta} = A B S ( L 1 - L 2 ) & Formula 1 \\ F 1 = \frac{{F}_{D elta}}{R ( FR 1 - FR 2 )} & Formula 2\end{matrix}$$

Additionally, the force applied on housing 104 by the user's hand, i.e., second force F2, can be found using a third formula where R_{bristle} is the approximate distance between the ends of the plurality of bristles 140 and first axis A1:

$$F 2 = \frac{L 1 - F 1 * FR 1 * R}{{R}_{B r i s t l e}} \qquad Formula 3$$

After total force FT, first force F1, and second force F2 have been determined, processor 120 can be arranged to provide feedback to the user and inform the user as to the source of the excessive pressure against the user's teeth. For example, if total force FT is determined to be above a first predefined threshold, e.g., 300g and first force F1/total force FT is greater than 0.5, processor 120 may be arranged to provide first feedback to the user in the form of a first unique notification, e.g., a first visual signal produced by a light source on or in housing 104, a first vibration in a first cadence or first pattern that is unique to an excessive first force F1, a first audible tone generated by a speaker arranged on or in housing 104, or a first wireless notification received on a peripheral device (e.g., a smart phone). Upon receiving this first feedback that first force F1 exceeds the first predefined threshold, the user can know that they should consider switching to a brush head having a smaller overall footprint, or a brush head that better conforms to the user's particular oral geometry. Additionally, if total force FT is determined to be above a first predefined threshold, e.g., 300g and second force F2/total force FT is greater than 0.5, processor 120 may be arranged to provide second feedback to the user in the form of a second unique notification, e.g., a second visual signal produced by a light source on or in housing 104, a second vibration in a second cadence or second pattern that is unique to an excessive second force F2, a second audible tone generated by a speaker arranged on or in housing 104, or a second wireless notification received on a peripheral device (e.g., a smart phone). Furthermore, it should be appreciated that, if first force F1 exceeds the first redefined threshold and second force F2 exceeds the second predefined threshold, processor 120 may be arranged to provide the first feedback and the second feedback to the user sequentially or simultaneously, or provide third feedback in the form of a third unique notification, e.g., a third visual signal produced by a light source on or in housing 104, a third vibration in a third cadence or second pattern that is unique to an excessive first force F1 and second force F2, a third audible tone generated by a speaker arranged on or in housing 104, or a third wireless notification received on a peripheral device (e.g., a smart phone).

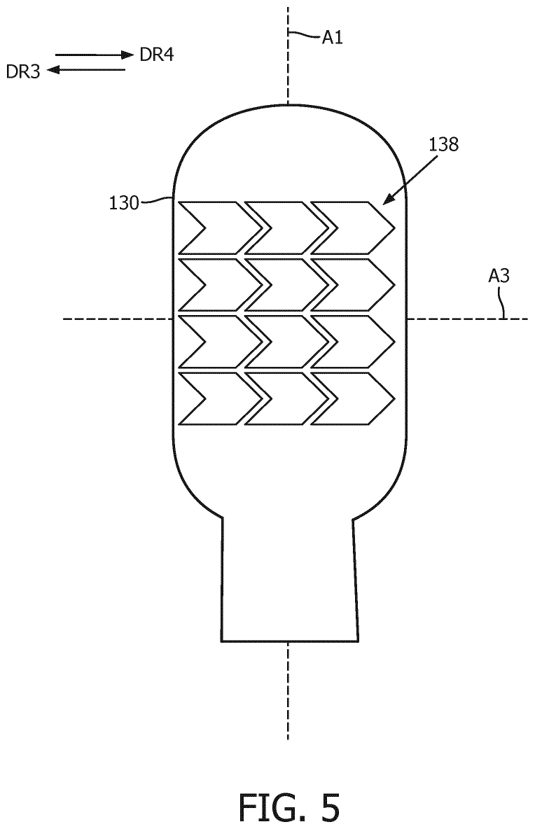

As illustrated in FIG. 5, it should be appreciated that the forgoing anisotropic effect on brush head 130 can also be achieved with a single surface, where the single surface is made of a material that provides a frictional load that differs depending on the direction in which it is dragged along the inside of the user's oral environment OE. For example, a felt material, or hook and loop fastener style material may be used where the material is arranged such that the coefficient of friction of the single material when dragged across the oral environment in third direction DR3 is different that the coefficient of friction of that same material when dragged across the oral environment in fourth direction DR4. In one example, macro or micro embossed or debossed patterns of the single material may be utilized to achieve this effect.

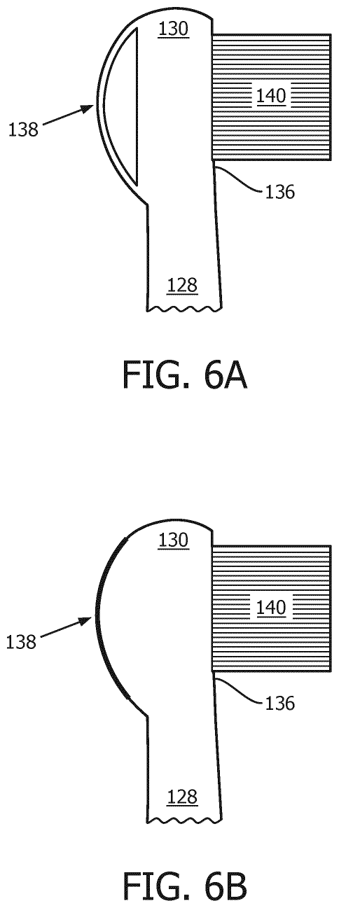

Furthermore, as illustrated in FIGS. 6A and 6B, the user may be able to derive first force F1 visually, directly from brush head 130 after operation. For example, a pressure sensitive film or polymer, pressure sensitive paint, strain reactive polymers, or piezo materials could be applied to the exterior surface of second face 138, as shown in FIG. 6A, or could be utilized in the formation of brush head 130 and be embedded or integrated within second face 138, as shown in FIG. 6B. If first force F1 exceeds the first predetermined threshold, the polymer or thin film may change color or color shift so that the user can visually determine if their oral environment is placing too much pressure or force on brush head 130 during operation of oral care appliance 100. It should also be appreciated that a piezo electric pressure sensor or mechanical strain gauge and moment arm could be utilized within brush head assembly 126; however, this would increase the overall expense of the brush head assembly 126.

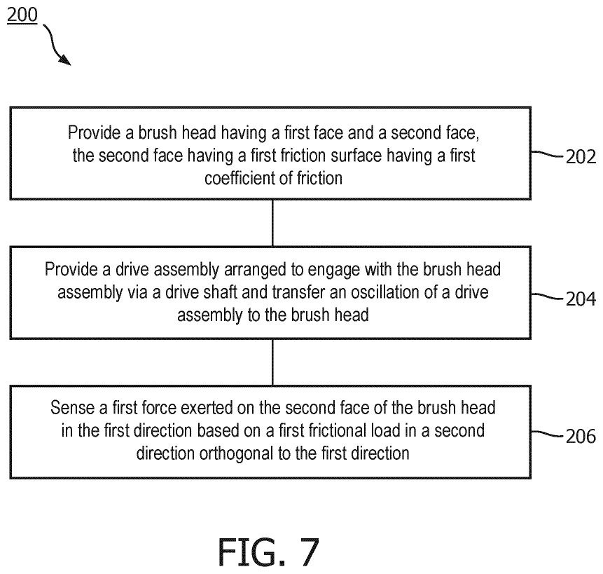

FIG. 7 illustrates a flow chart containing the steps of method 200 according to the present disclosure. Method 200 can include, for example: providing a brush head assembly 126 having brush head 130, the brush head 130 having a first face 136 and a second face 138, the first face 138 arranged to engage with a plurality of bristles 140 extending therefrom in a first direction DR1 and the second face 138 having a first friction surface 142 arranged thereon, the first friction surface 142 having a first coefficient of friction FR1 (step 202); providing, within a housing 104 of the personal care appliance 100, a drive assembly 112 arranged to engage with the brush head assembly 126 via a drive shaft 116 and transfer an oscillation of the drive assembly 112 to the brush head (step 204); sensing, via a first sensor 124 arranged within the housing 104, a first force F1 exerted by an oral environment OE on the second face 138 of the brush head 130 in the first direction DR1 based at least in part on a first frictional load between the first friction surface 142 of the second face 138 of the brush head 130 and the oral environment OE in a third direction DR3, wherein the third direction DR3 is orthogonal to the first direction DR1 (step 206). Additionally, the second face 138 of the brush head 130 further comprises a second friction surface 144 having a second coefficient of friction FR2, where the second coefficient of friction FR2 is different than the first coefficient of friction FR1, and the first friction surface 142 comprises a first friction material having the first coefficient of friction FR1 along the third direction DR3 and a second friction material having a second coefficient of friction along a fourth direction DR4 where the fourth direction DR4 is opposite the third direction DR3.

All definitions, as defined and used herein, should be understood to control over dictionary definitions, definitions in documents incorporated by reference, and/or ordinary meanings of the defined terms.

The indefinite articles “a” and “an,” as used herein in the specification and in the claims, unless clearly indicated to the contrary, should be understood to mean “at least one.”

The phrase “and/or,” as used herein in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified.

As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e. “one or the other but not both”) when preceded by terms of exclusivity, such as “either,” “one of,” “only one of,” or “exactly one of.”

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified.

It should also be understood that, unless clearly indicated to the contrary, in any methods claimed herein that include more than one step or act, the order of the steps or acts of the method is not necessarily limited to the order in which the steps or acts of the method are recited.

In the claims, as well as in the specification above, all transitional phrases such as “comprising,” “including,” “carrying,” “having,” “containing,” “involving,” “holding,” “composed of,” and the like are to be understood to be open-ended, i.e., to mean including but not limited to. Only the transitional phrases “consisting of” and “consisting essentially of” shall be closed or semi-closed transitional phrases, respectively.

While several inventive embodiments have been described and illustrated herein, those of ordinary skill in the art will readily envision a variety of other means and/or structures for performing the function and/or obtaining the results and/or one or more of the advantages described herein, and each of such variations and/or modifications is deemed to be within the scope of the inventive embodiments described herein. More generally, those skilled in the art will readily appreciate that all parameters, dimensions, materials, and configurations described herein are meant to be exemplary and that the actual parameters, dimensions, materials, and/or configurations will depend upon the specific application or applications for which the inventive teachings is/are used. Those skilled in the art will recognize, or be able to ascertain using no more than routine experimentation, many equivalents to the specific inventive embodiments described herein. It is, therefore, to be understood that the foregoing embodiments are presented by way of example only and that, within the scope of the appended claims and equivalents thereto, inventive embodiments may be practiced otherwise than as specifically described and claimed. Inventive embodiments of the present disclosure are directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the inventive scope of the present disclosure.

1. A brush head assembly for a personal care appliance, the brush head assembly comprising:
a first face fixedly secured to a plurality of bristles, the plurality of bristles arranged to extend from the first face in a first direction; and
a second face arranged to create a first frictional force between the second face and an oral environment in in a second direction, and create a second frictional force between the second face and the oral environment in a third direction.

2. The brush head assembly of claim 1, wherein the second face further comprises a first friction surface having a first coefficient of friction and a second friction surface having a second coefficient of friction, where the second coefficient of friction is different than the first coefficient of friction.

3. The brush head assembly of claim 2, wherein the second face further comprises a first plurality of protrusions, the first plurality of protrusions including a first protrusion, the first protrusion having a first side and a second side, wherein the first friction surface is arranged on the first side of the first protrusion and the second friction surface is arranged on the second side of the first protrusion.

4. The brush head assembly of claim 3, wherein the second face further comprises a third friction surface having the first coefficient of friction and a fourth friction surface having the second coefficient of friction wherein the first coefficient of friction and the second coefficient of friction are substantially equal.

5. The brush head assembly of claim 4, wherein the first plurality of protrusions includes a second protrusion, the second protrusion having a third side and a fourth side, wherein the third friction surface is arranged on the third side of the second protrusion and the fourth friction surface is arranged on the fourth side of the second protrusion.

6. The brush head assembly of claim 2, wherein the first friction surface comprises a first friction material having the first coefficient of friction along the second direction and a second friction material having a second coefficient of friction along the third direction.

7. A personal care appliance, the personal care appliance comprising:
a brush head assembly comprising:
a neck having a first end and a second end;
a brush head arranged proximate the first end of the neck, the brush head comprising:
a first face fixedly secured to a plurality of bristles, the plurality of bristles arranged to extend from the first face in a first direction; and,
a second face having a first friction surface arranged thereon, the first friction surface having a first coefficient of friction; and,
a body portion having a housing, the housing having third end and a fourth end, the housing comprising a cavity therein, the cavity comprising:
a drive shaft arranged proximate the third end of the body portion and arranged to engage with the second end of the neck;
a drive assembly arranged to generate an oscillation of the drive shaft and, via the drive shaft, generate an oscillation of the brush head; and,
a first sensor arranged to determine a first force exerted by an oral environment on the second face of the brush head in the first direction based at least in part on a first frictional load between the first friction surface of the second face of the brush head and the oral environment in a second direction, wherein the second direction is orthogonal to the first direction.

8. The personal care appliance of claim 7, wherein the second face of the brush head further comprises a second friction surface having a second coefficient of friction, where the second coefficient of friction is different than the first coefficient of friction.

9. The personal care appliance of claim 8, wherein the second face of the brush head further comprises a first plurality of protrusions, the first plurality of protrusions including a first protrusion, the first protrusion having a first side and a second side, wherein the first friction surface is arranged on the first side of the first protrusion and the second friction surface is arranged on the second side of the first protrusion.

10. The personal care appliance of claim 9, wherein the second face of the brush head further comprises a third friction surface having the first coefficient of friction and a fourth friction surface having the second coefficient of friction wherein the first coefficient of friction and the second coefficient of friction are not equal.

11. The personal care appliance of claim 10, wherein the first plurality of protrusions includes a second protrusion, the second protrusion having a third side and a fourth side, wherein the third friction surface is arranged on the third side of the second protrusion and the fourth friction surface is arranged on the fourth side of the second protrusion.

12. The personal care appliance of claim 7, wherein the first friction surface comprises a first friction material having the first coefficient of friction along the second direction and a second friction material having a second coefficient of friction along a third direction where the third direction is opposite the second direction.

13. A method of differentiating pressure on a personal care appliance the method comprising:
providing a brush head assembly having brush head, the brush head having a first face and a second face, the first face arranged to engage with a plurality of bristles extending therefrom in a first direction and the second face having a first friction surface arranged thereon, the first friction surface having a first coefficient of friction;
providing, within a housing of the personal care appliance, a drive assembly arranged to engage with the brush head assembly via a drive shaft and transfer an oscillation of the drive assembly to the brush head;
sensing, via a first sensor arranged within the housing, a first force exerted by an oral environment on the second face of the brush head in the first direction based at least in part on a first frictional load between the first friction surface of the second face of the brush head and the oral environment in a second direction.

14. The method of claim 13, wherein the second face of the brush head further comprises a second friction surface having a second coefficient of friction, where the second coefficient of friction is different than the first coefficient of friction.

15. The method of claim 13, wherein the first friction surface comprises a first friction material having the first coefficient of friction along the second direction and a second friction material having a second coefficient of friction along a third direction where the third direction is opposite the second direction.
